(19) United States
(12) Patent Application Publication
(10) Pub. No.: US 2010/0064660 A1
(43) Pub. Date: Mar. 18, 2010

(54) JET ENGINE NACELLE MEMBER

(75) Inventors: Guy Bernard Vauchel, Le Havre (FR); Jean Paul Rene Andre Hogie, Le Havre (FR)

Correspondence Address: CANTOR COLBURN, LLP, 20 Church Street, 22nd Floor, Hartford, CT, 06103, US

(73) Assignee: AIRCELLE, GONFREVILLE L'ORCHER (FR)

(21) Appl. No.: 12/513,432

(22) PCT Filed: Sep. 27, 2007
(86) PCT No.: PCT/FR07/01580

§ 371 Date: May 4, 2009

(30) Foreign Application Priority Data
Nov. 3, 2006 (FR) 0609608

(51) Int. Cl. F02K 3/02; F02G 3/00

(52) U.S. Cl. 60/226.2; 60/39.093

(57) ABSTRACT

The invention relates to an nacelle member (1) comprising at least one mobile cowling (2) pivotally or slidably mounted in an essentially longitudinal direction of the nacelle, capable of displacement between an expanded position and a closed position relative to a fixed structure of the nacelle member (1) through at least one pivoting or translation guiding sleeve (4, 7) that receives a guiding shaft (5, 6). An electric heating de-icing device (9, 13) is provided inside the guiding shaft or defines an interface between the guiding shaft (5, 6) and the guiding sleeve (4, 7).

### FIELD OF THE INVENTION

The present invention relates to a jet engine nacelle member, in particular a thrust reverser.

### BACKGROUND OF THE INVENTION

An aircraft is propelled by a number of jet engines each housed in a nacelle which also accommodates a collection of auxiliary actuating devices which are associated with its operation and which perform various functions when the jet engine is operating or at a standstill. These auxiliary actuating devices comprise in particular a mechanical system for actuating thrust reversers.

A nacelle generally has a tubular structure comprising an air inlet upstream of the jet engine, a mid-section intended to surround a fan of the jet engine, and a downstream section accommodating thrust reversal means and intended to surround the combustion chamber of the jet engine, and is generally terminated by an exhaust nozzle whose outlet is situated downstream of the jet engine.

Modern nacelles are intended to accommodate a dual-flow jet engine, or turbofan, which, by means of the rotating fan blades, is capable of generating a hot airflow (also known as the primary flow) from the combustion chamber of the jet engine, and a cold airflow (secondary flow) which flows around outside the jet engine through an annular passage, also known as a duct, formed between a cowling of the jet engine and an internal wall of the nacelle. The two airflows are ejected from the jet engine via the rear end of the nacelle.

The job of a thrust reverser is to improve the braking capability of an aircraft when it is landing by redirecting forward at least some of the thrust generated by the jet engine. In this phase, the reverser obstructs the cold flow duct and directs this cold flow toward the front of the nacelle, thereby generating a counter-thrust which combines with the braking of the aircraft wheels.

The means employed to achieve this reorientation of the cold flow vary according to the type of reverser. However, in all cases, the structure of a reverser comprises movable cowls which can be moved, in general by means of sleeves or tracks accommodating a guide shaft, between, on the one hand, a deployed position in which they open up, within the nacelle, a passage intended for the deflected flow and, on the other hand, a stowed position in which they close off this passage. These cowls may perform a deflection function or a function of simply activating other deflection means.

A thrust reverser is required to perform its function within a wide range of atmospheric conditions, particularly at very low temperatures which may reach minus 55° C.

In the event of an aborted takeoff of an aircraft, for example, that is to say when the pilot has to land urgently barely after the start of takeoff, the system for actuating the thrust reversers must be able to be actuated urgently without waiting for the entire nacelle to be thermally stabilized by the heat produced by each jet engine.

In these conditions, ice or frost may still be present in the sleeves or tracks used to guide the movable cowls of the thrust reversers and may retard or even block the actuation of the thrust reversers.

In a general manner, the same difficulties may be faced with any type of jet engine nacelle member comprising cowls which can be pivoted or moved translationally with respect to a fixed structure of a nacelle member.

### BRIEF SUMMARY OF THE INVENTION

The present invention aims to overcome these disadvantages and for that purpose consists of a jet engine nacelle member comprising at least one movable cowl which is mounted pivotably or slidably in a substantially longitudinal direction of the nacelle, between a deployed position and a closed position with respect to a fixed structure of the nacelle member, by means of at least one sleeve for guiding the pivoting or translational movement, said sleeve accommodating a guide shaft, and wherein a heating electric deicing device is arranged inside the guide shaft, or forms an interface between the guide shaft and the guide sleeve.

The confined environment and the clearances between the guide sleeve and guide shaft do not allow the ice to form a thick layer. As a result, short-term heating in the vicinity of the ice region can quickly convert the ice to water so as to allow the movable cowl to move under normal operating conditions.

According to one possibility, the heating electric deicing device is arranged on an interface liner, in particular made of a plastic or organic material, and mounted on an internal wall of the guide sleeve.

In this context, the deicing device is preferably arranged on a surface of the interface liner that is predetermined so as to be only slightly stressed by the movement of the guide shaft in the sleeve.

According to another possibility, the deicing device, arranged inside the guide shaft, is connected to electric supply means, provided on the fixed structure of the nacelle member, by means of an electrically conductive and elastically deformable element whose deformation is aimed at compensating for the movement of the guide shaft with respect to the fixed structure of the nacelle member.

The deicing device may comprise a metallic or organic base.

The deicing device comprises, for example, a reflective strip with the aim of concentrating the heat released by the deicing device between the guide shaft and the guide sleeve.

The activation of the deicing device may be controlled as a function of a signal from a temperature or ice detector.

In an advantageous manner, the activation of the deicing device is triggered automatically from the start of the thrust reversal.

The nacelle member may be a thrust reverser.

In that case, the activation of the deicing device may be triggered automatically from the start of the thrust reversal.

The nacelle member is, for example, a cascade-type thrust reverser in which the guide sleeve is a track and the guide shaft is a runner.

### BRIEF DESCRIPTION OF THE DRAWINGS

The way in which the invention is implemented will be better understood from the detailed description set forth below with reference to the appended drawing.

FIG. 1 is a partial schematic view in cross section of a jet engine nacelle member according to a first embodiment of the invention.

FIG. 2 is an enlarged view of a detail in FIG. 1.

FIG. 3 is a partial view in longitudinal section in the direction of the arrow III in FIG. 2.

FIG. 4 illustrates the structure of deicing devices equipping the above nacelle member.

FIG. 5 is a further-enlarged view of a detail in FIG. 2.

FIG. 6 represents a deicing device in FIG. 5.

FIG. 7 is an analogous view to FIG. 2 showing a variant embodiment of the invention.

FIG. 8 represents a deicing device in FIG. 7.

FIG. 9 is an analogous view to FIGS. 2 and 7 showing another variant embodiment of the invention.

FIG. 10 is a partial view in longitudinal section in the direction of the arrow X in FIG. 9.

### DETAILED DESCRIPTION OF THE PREFERRED EMBODIMENTS

FIG. 1 represents an example of a jet engine nacelle member according to the invention, here produced in the form of a cascade-type thrust reverser 1.

In a manner known per se and not detailed hereinafter, the thrust reverser 1 comprises, on the one hand, cascades (not shown) for deflecting a fraction of an airflow of the jet engine (not shown) and, on the other hand, two cowls 2 which can move translationally in a substantially longitudinal direction of the nacelle and which are able to switch alternately from a closed position, in which they provide the nacelle with aerodynamic continuity and cover the deflection cascades, to an open position in which they open up a passage in the nacelle and uncover the deflection cascades.

Complementary blocker doors (not shown), which are activated by the sliding movement of the cowling 2, generally make it possible to close off the duct downstream of the cascades so as to optimize the reorientation of the cold flow.

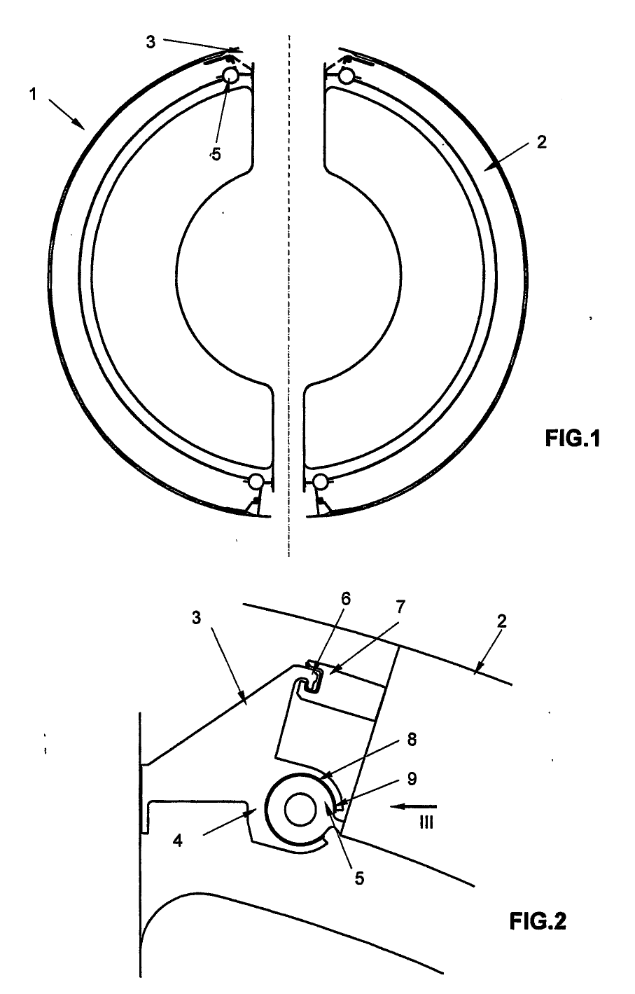

As illustrated more clearly in FIG. 2, the movable cowls 2 are slidably mounted on carrier fittings 3 which are arranged in lower and upper portions of a fixed structure of the reverser 1.

Each carrier fitting 3 comprises a substantially cylindrical primary guide track 4 intended for accommodating a primary guide runner 5 of a cowl 2.

In parallel, each cowl 2 has a secondary guide track 7 of substantially rectangular profile that is intended to accommodate a secondary guide runner 6 of the corresponding carrier fitting 3.

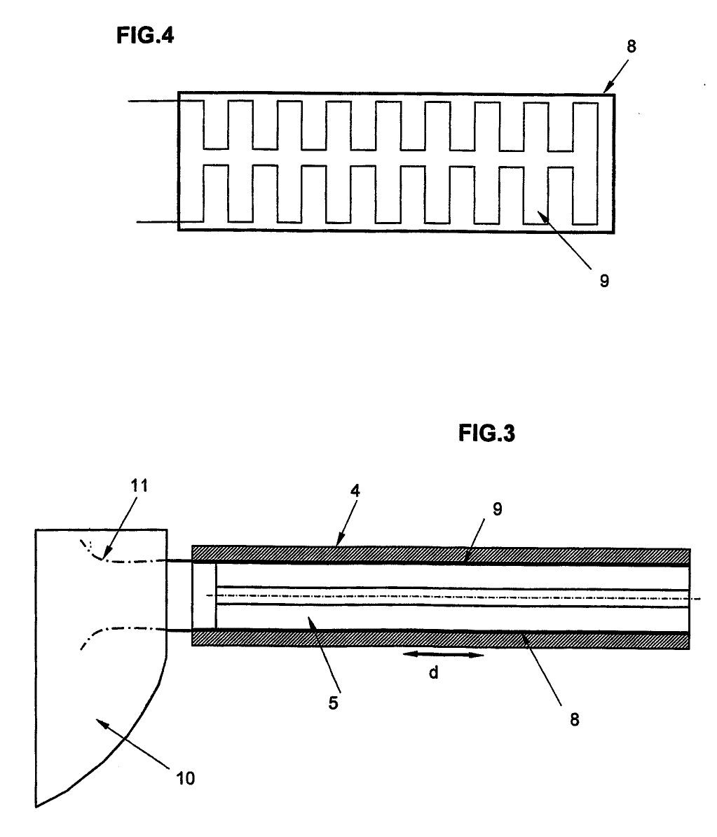

As indicated more clearly in FIGS. 3 and 4, a heating electric deicing device 9 is arranged on a liner 8 forming an interface between each runner 5 and the corresponding guide track 4.

The interface liner 8 is made here from a material such as Teflon, and it is mounted on an internal wall of the guide track 4.

The heating electric deicing device 9 comprises a wire metallic base (see FIG. 4) fixed to a reflective strip (not shown) and electrically connected at 11 to an electric supply box (not shown) on a fixed upstream structure 10 of the reverser 1.

The reflective strip makes it possible to concentrate the heat released by the deicing device 9 toward a region between the runner 5 and its guide track 4, and thus save energy.

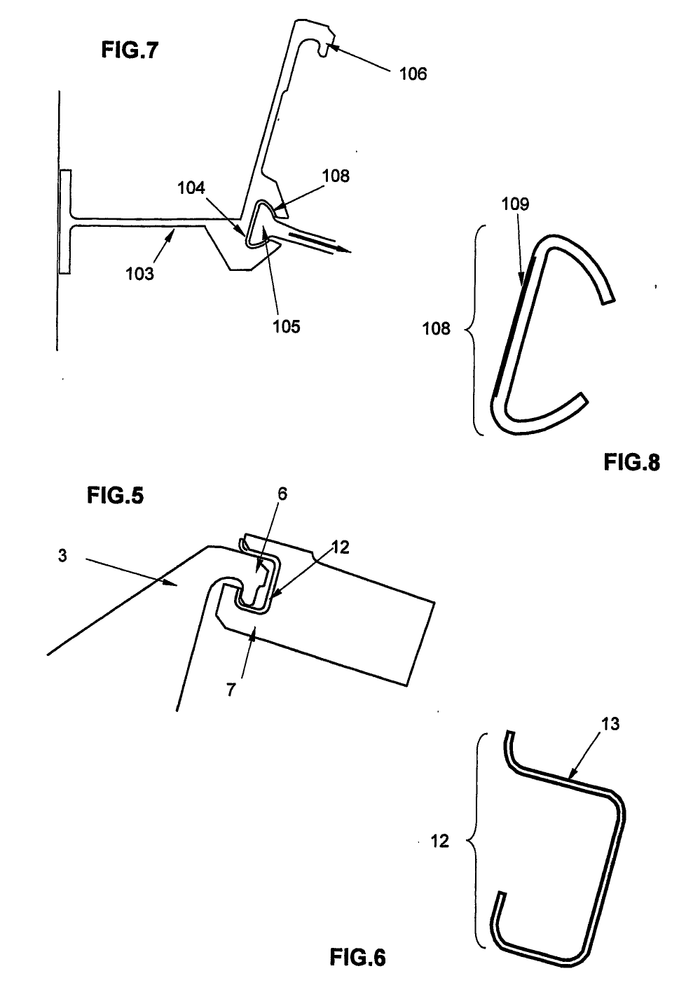

As is apparent from FIGS. 5 and 6, a second deicing device 13, which is analogous to the device 9 presented above, is arranged on an interface liner 12 mounted on an internal wall of the secondary guide track 7.

The interface liners 8 and 12 could also be integrated into the corresponding guide tracks 4 and 7.

In the embodiment illustrated in FIGS. 7 and 8, the carrier fitting 103 comprises a primary guide track 104 having a profile in the form of a “D” which is open in its convex portion. The interface liner 108 has an identical profile and it tightly encloses a primary guide runner 105 having a complementary profile.

The regions of the track 104 which are most stressed by the runner 105 during its translational movement are the two curved legs situated one on each side of the opening of the “D”-shaped profile of the track 104, while the planar rear surface of the track 104 is only slightly stressed, if at all, by the runner 105.

The rectilinear portion (the vertical bar of the “D”) of the profile of the liner 108 is thus likewise little stressed during the sliding movement d of the runner 105. The heating electric deicing device 109 is therefore placed on this planar surface of the liner 108 that is little subject to wear (see FIG. 8). This planar surface is sufficiently large to ensure sufficient heating and, through its shape, it makes it easier to place the deicing device 109 on the liner 108.

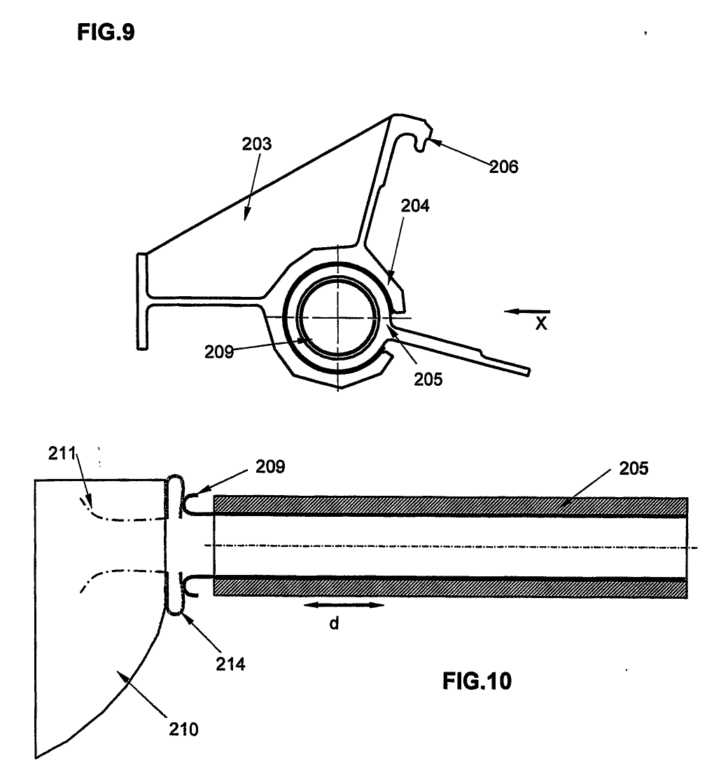

FIGS. 9 and 10 illustrate another variant embodiment of the invention, in which a heating electric deicing device 209 is directly integrated into a primary guide runner 205 of the cowl.

It should be noted that FIG. 10 is a schematic view in which, for the sake of greater clarity, the track 204 has not been represented.

The deicing device 209 is arranged on a tubular inner wall of the guide runner 205. As above, the deicing device 209 is electrically connected, at 211, to an electric supply box (not shown) on a fixed upstream structure 210 of the reverser 1.

However, this electrical connection is in this case produced via an elastically deformable electrically conducting element 214 which is designed to provide electrical continuity between the deicing device 209, which is now translationally movable since it is combined with the guide runner 205, and the electrical supply circuit 211 arranged fixedly on the fixed upstream structure 210 of the reverser 1.

The elastic deformation of the electrically conducting element 214 makes it possible to compensate for the positioning tolerances with the translationally movable deicing device 209 according to the movement.

This embodiment does not require an interface liner since the deicing device 209 here provides heating for the runner 205 alone.

In all the embodiments specified above, the activation of the deicing devices 9, 13, 109 or 209 may be systematic, in particular from the start of the thrust reversal, and/or controlled (via an electronic control and/or power system of the reverser) as a function of a signal from a detector (not shown) for detecting temperature or ice in the environment of the corresponding track 4, 7, 104 or 204.

Although the invention has been described using specific embodiments, it is quite obvious that it is in no way limited thereto and that it encompasses all technical equivalents of the means described and combinations thereof where these come within the scope of the invention.

1. A jet engine nacelle member comprising at least one movable cowl which is mounted pivotably or slidably in a substantially longitudinal direction of a nacelle, between a deployed position and a closed position with respect to a fixed structure of the nacelle member, by means of at least one sleeve for guiding a pivoting or a translational movement, said sleeve accommodating a guide shaft, wherein a heating electric deicing device is arranged inside the guide shaft, or forms an interface between the guide shaft and the guide sleeve.

2. The nacelle member as claimed in claim 1, wherein the deicing device is arranged on an interface liner, made of a plastic or organic material, and mounted on an internal wall of the guide sleeve.

3. The nacelle member as claimed in claim 2, wherein the deicing device is arranged on a surface of the interface liner that is predetermined so as to be only slightly stressed by a movement of the guide shaft in the sleeve.

4. The nacelle member as claimed in claim 1, wherein the deicing device, arranged inside the guide shaft, is connected to electric supply means, provided on the fixed structure of the nacelle member, by means of an electrically conductive and elastically deformable element.

5. The nacelle member as claimed in claim 1, wherein the deicing device comprises a metallic or organic base.

6. The nacelle member as claimed in claim 1, wherein the deicing device comprises a reflective strip configured to concentrate heat released by the deicing device between the guide shaft and the guide sleeve.

7. The nacelle member as claimed in claim 1, wherein activation of the deicing device is controlled as a function of a signal from a temperature or ice detector.

8. The nacelle member as claimed in claim 1, wherein the nacelle member is a thrust reverser.

9. The nacelle member as claimed in claim 8, wherein activation of the deicing device is triggered automatically from a start of a thrust reversal.

10. The nacelle member as claimed in claim 8, wherein the nacelle member is a cascade-type thrust reverser in which the guide sleeve is a track and the guide shaft is a runner.

11. The nacelle member as claimed in claim 1, wherein said nacelle member comprises a thrust reverser.
